(19) United States
(12) Patent Application Publication
(10) Pub. No.: US 2018/0245774 A1
(43) Pub. Date: Aug. 30, 2018

(54) LIGHTING DEVICE

(71) Applicant: LG INNOTEK CO., LTD., Seoul (KR)

(72) Inventor: Sung Ku KANG, Seoul (KR)

(73) Assignee: LG Innotek Co., Ltd., Seoul (KR)

(21) Appl. No.: 15/751,321

(22) PCT Filed: Aug. 16, 2016
(86) PCT No.: PCT/KR2016/008972

§ 371 Date: Feb. 8, 2018

(30) Foreign Application Priority Data
Aug. 19, 2015 (KR) 10-2015-0116453

(51) Int. Cl. F21V 13/02; F21V 7/00; F21V 7/04; F21V 7/10

(52) U.S. Cl. CPC F21V 13/02; F21V 7/0008; F21Y 2115/10; F21V 7/10; F21V 7/04

(57) ABSTRACT

The present invention comprises: a lighting emitting part comprising a board and a plurality of light emitting devices disposed on the board; a reflecting part having a reflective surface which faces the light emitting devices; and a plurality of protruding parts which are disposed to be spaced apart from one another on the reflective surface so as to correspond to the light emitting devices and reflect light radiated from the light emitting devices, wherein each of the plurality of protruding parts has a shape in which the length of a first direction is greater than the length of a second direction and the reflective surface comprises a curved surface part which is curved in the first direction, wherein the first direction is a direction from the reflective surface towards the light emitting part, and the second direction is perpendicular to the first direction.

### TECHNICAL FIELD

Embodiments relate to a lighting device including light emitting devices.

### BACKGROUND ART

In general, a light emitting diode (hereinafter referred to as an ‘LED’) is a device which emits light by combination of electrons and holes in a P-N junction by applying current, and the LED may have various advantages, such as continuous emission of light at low voltage and low current, low power consumption, etc., as compared to conventional light sources.

Particularly, LEDs are widely used as light sources in various display apparatuses, backlights, etc., technology in which three light emitting diode chips emitting light of red, green and blue are used or white light is emitted by converting a wavelength using phosphors has been developed recently, and, thus, application of LEDs is extended.

### DISCLOSURE

### Technical Problem

Embodiments provide a lighting device which may improve uniformity of luminance.

### Technical Solution

In one embodiment, a lighting device includes a light emission unit including a board and a plurality of light emitting devices arranged on the board, a reflector having a reflective surface facing the light emitting devices, and a plurality of protruding parts arranged on the reflective surface to be spaced apart from one another so as to correspond to the light emitting devices and reflecting light radiated from the light emitting devices, wherein each of the protruding parts has a shape having a length thereof in a first direction being greater than a length thereof in a second direction, and the reflective surface includes a curved surface part being curved in the first direction, wherein the first direction is a direction from the reflective surface to the light emission unit, and the second direction is perpendicular to the first direction.

An interface between the lower surface of each of the protruding parts and the reflective surface may be a curved surface.

The protruding parts may be arranged on the reflective surface so as to be spaced apart from one another obliquely from a reference horizontal line, and the reference horizontal line may be a virtual straight line being parallel to the second direction.

Distances between two neighboring protruding parts out of the protruding parts may be the same.

Each of the protruding parts may protrude continuously from one end of the reflective surface to the other end of the reflective surface.

An angle formed by each of the protruding parts and the reference horizontal line may be 40°˜55°.

A distance between each of the light emitting devices and a reference vertical line may be 5 mm˜15 mm, and the reference vertical line may be a virtual straight line passing through one end of one of the protruding parts corresponding to the light emitting device and being parallel to the first direction.

Each of the protruding parts may have a semicircular cross-section taken in the second direction.

The reflective surface may further include a flat surface part contacting the curved surface part and being flat, and each of the protruding parts may be arranged on the curved surface part and the flat surface part.

The lighting device may further include a support frame having a lower surface provided with one end contacting an upper end of the board, and a diffusion plate fixed to the end of the support frame and the upper end of the board.

The lighting device may further include a first reflective member arranged on the lower surface of the support frame, and a second reflective member arranged on the reflective surface so as to face the first reflective member.

The reflector may include a protrusion contacting one end of the flat surface part and protruding upwardly, and a staircase part supporting the board may be provided on the protrusion.

A distance between ends of two neighboring protruding parts may be equal to a distance between the other ends of the two neighboring protruding parts.

Each of the protruding parts may have constant width and thickness in the length direction thereof.

The protruding parts may be formed of a reflective material.

Each of the protruding parts may include a plurality of divided protrusions arranged so as to be spaced apart from one another.

The lighting device may further include a housing having a cavity to receive the light emission unit, the reflector, the protruding parts, the support frame and the diffusion plate.

A distance from a first side surface of the reflector to the reflective surface may be gradually decreased in a direction from a lower end to an upper end of the reflector.

In another embodiment, a lighting device includes a light emission unit including a board and a plurality of light emitting devices arranged on the board, a reflector including a reflective surface including a curved surface facing the light emitting devices and a plurality of protruding parts arranged on the reflective surface, and a diffusion plate arranged on the reflector and transmitting light reflected by the reflective surface, wherein each of the protruding parts has a shape having a length thereof in a first direction being greater than a length thereof in a second direction and is arranged on the reflective surface obliquely so as to correspond to one of the light emitting devices, an angle formed by each of the protruding parts and a reference horizontal line is 40°˜55°, the first direction is a direction from the reflective surface to the light emission unit, the second direction is perpendicular to the first direction, and the reference horizontal line is a virtual straight line being parallel to the second direction.

In yet another embodiment, a lighting device includes a light emission unit including a board and a plurality of light emitting devices arranged on the board, a reflector including a reflective surface including a curved surface facing the light emitting devices and a plurality of protruding parts arranged on the reflective surface so as to correspond to the light emitting devices, and a diffusion plate arranged on the reflector and transmitting light reflected by the reflective surface, wherein each of the protruding parts has a shape having a length thereof in a first direction being greater than a length thereof in a second direction, the protruding parts are arranged on the reflective surface so as to be spaced apart from one another obliquely, a distance between each of the light emitting devices and a reference vertical line is 5 mm˜15 mm, and the reference vertical line is a virtual straight line passing through one end of the protruding part corresponding to each of the light emitting devices and being parallel to the first direction.

### Advantageous Effects

A lighting device in accordance with one embodiment may improve uniformity of luminance.

### DESCRIPTION OF DRAWINGS

FIG. 1 is a perspective view of a lighting device in accordance with one embodiment.

FIG. 2 is a cross-sectional view of the lighting device shown in FIG. 1, taken along line A-B.

FIG. 3 is a perspective view illustrating a light emission unit shown in FIG. 2 in accordance with one embodiment.

FIG. 4 is a perspective view illustrating a reflector shown in FIG. 2 in accordance with one embodiment.

FIGS. 5A to 5D are views illustrating protruding parts shown in FIG. 4 in accordance with embodiments.

FIG. 6A is a view illustrating arrangement relations between light emitting devices of the light emission unit and a plurality of protruding parts.

FIG. 6B is a view illustrating a plurality of protruding parts in accordance with another embodiment.

FIG. 7 is a table representing results of a simulation illustrating uniformities of luminance of an A-line and a B-line of a lighting device in accordance with one embodiment.

FIG. 8 is a table representing results of a simulation in which uniformity of luminance of the B-line according to change in an angle θ1 of FIG. 6A is measured.

FIG. 9 is a table representing results of a simulation in which uniformity of luminance of the B-line according to change of a distance of FIG. 6A is measured.

FIG. 10 is a cross-sectional view of a lighting device in accordance with another embodiment.

FIG. 11 is a cross-sectional view of a lighting device in accordance with yet another embodiment.

FIG. 12 is a table representing results of a simulation illustrating uniformities of luminance of an A-line and a B-line of the lighting device shown in FIG. 10.

### BEST MODE

Hereinafter, embodiments will be described with reference to the annexed drawings and description. In the following description of the embodiments, it will be understood that, when each element, such as a layer (film), region, pattern or structure, is referred to as being formed “on” or “under” another element, such as a substrate, another layer (film) region, pad or pattern, it can be directly “on” or “under” the other element or be indirectly formed with one or more intervening elements therebetween. Further, a reference to the upward or downward direction of each element is described based on the drawings.

In the drawings, sizes of elements may be exaggerated, reduced or schematically illustrated for convenience and clarity of description. Further, the sizes of the elements do not reflect the actual sizes of the elements. In addition, in the drawings, the same or similar elements are denoted by the same reference numerals even though they are depicted in different drawings.

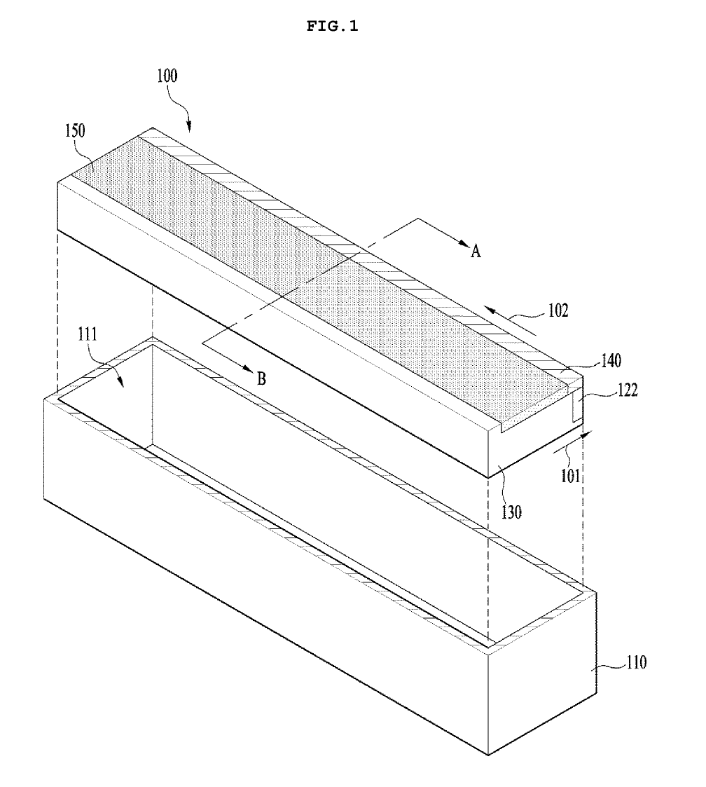

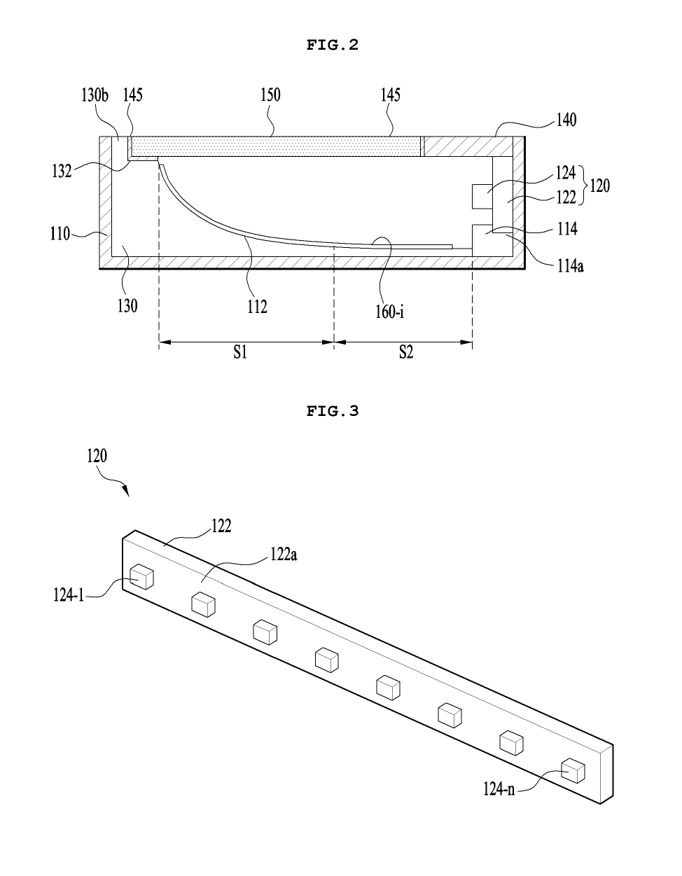

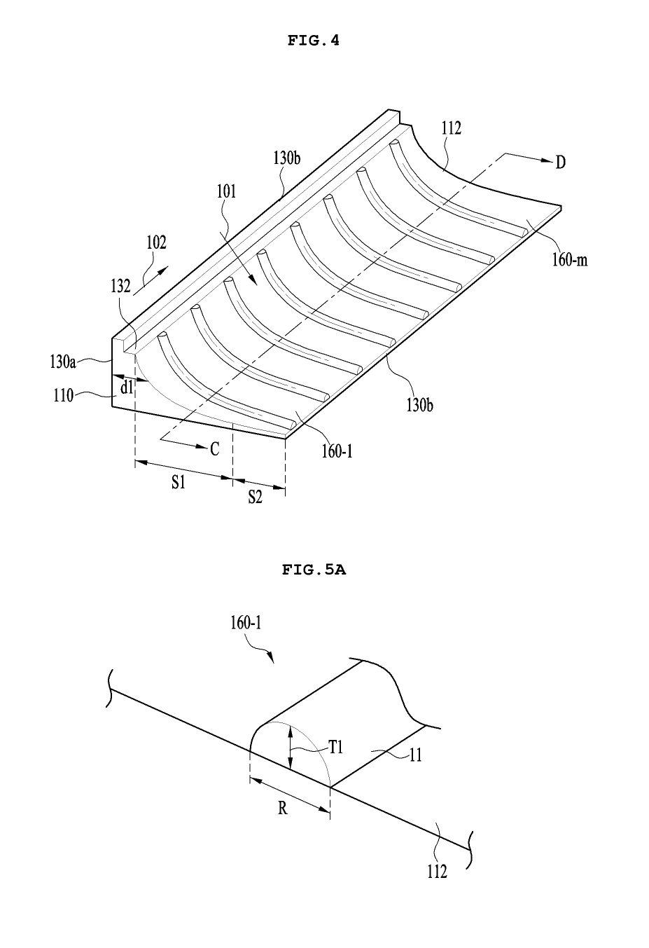

FIG. 1 is a perspective view of a lighting device 100 in accordance with one embodiment, FIG. 2 is a cross-sectional view of the lighting device 100 shown in FIG. 1, taken along line A-B, FIG. 3 is a perspective view illustrating a light emission unit 120 shown in FIG. 2 in accordance with one embodiment, and FIG. 4 is a perspective view illustrating a reflector 130 shown in FIG. 2 in accordance with one embodiment.

With reference to FIGS. 1 and 2, the lighting device 100 includes a housing 110, a light emission unit 120, a reflector 130, a support frame 140 and a diffusion plate 150.

The housing 110 has a cavity 111 to receive the light emission unit 120, the reflector 130, the support frame 130 and the diffusion plate 150.

The housing 140 may be formed of plastic having light weight and high thermal resistance or a metal having high thermal conductivity, for example, aluminum. The inner surface of the cavity 111 of the housing 110 may be coated with a reflective material which may reflect light radiated from the light emission unit 120. Otherwise, in accordance with another embodiment, the housing 110 may be formed of a reflective material which may reflect light.

The light emission unit 120 is arranged in the cavity 111 of the housing 110 and radiates light.

With reference to FIG. 3, the light emission unit 120 may include a board 122 and light emitting devices 124. The board 122 of the light emission unit 120 may have a plate-shaped structure on which the light emitting devices 124 may be mounted or a device to supply power to the light emitting devices 124 or to control or protect the light emitting devices 124 may be mounted.

For example, the board 122 may be a printed circuit board and a metal PCB. Although FIG. 3 illustrates the board 122 as having a rectangular parallelepiped shape, without being limited thereto, the board 122 may have a circular, oval or polyhedral plate shape.

The light emission devices 124 may be arranged on one surface (for example, the upper surface) of the board 122. The light emitting devices 124 may be light emitting diode (LED)-based light sources but are not limited thereto. For example, the light emitting devices 124 may be provided as light emitting diode chips or light emitting diode packages.

The number of the light emitting devices 124 may be one or more. FIG. 3 illustrates a plurality of light emitting devices 124-1 to 124-n (n being a natural number>1) as being arranged on the board 122 in a row, but the disclosure is not limited thereto. A plurality of light emitting devices 124-1 to 124-n (n being a natural number>1) may be arranged on the board 122 in various types, such as a circular type, a radial type or a matrix type.

The light emitting devices 124-1 to 124-n (n being a natural number>1) may emit light having the same or similar wavelength range, for example, light of blue, red, green or white. Otherwise, at least one of the light emitting devices 124-1 to 124-n (n being a natural number>1) may emit light of a wavelength range differing from that of other light emitting devices 124-1 to 124-n (n being a natural number>1).

The reflector 130 is arranged in the housing 110 so as to face the light emission unit 120 and reflects light radiated from the light emission unit 120.

The reflector 130 may include a reflective surface 122 facing the light emission unit 120, and a plurality of protruding parts 160-1 to 160-m (m being a natural number>1) arranged on the reflective surface 122.

The reflective surface 122 of the light emission unit 120 may include a curved surface reflecting light irradiated from the light emission unit 120 in the upward direction.

A length of the reflective surface 112 in a first direction 101 may be shorter than a length of the reflective surface 112 in a second direction 102. Hereinafter, the first direction 101 may be a direction from the reflective surface 112 to the light emission unit 120, and the second direction 102 may be a direction perpendicular to the first direction. For example, the first direction 101 may be a length direction of a short side of the reflective surface 112, and the second direction 102 may be a length direction of a long side of the reflective surface 112.

A distance D1 from a first side surface 130a of the reflector 130 to the reflective surface 112 may be gradually decreased in a direction from the lower end to the upper end of the reflector 130. Further, the first side surface 130a of the reflector 130 and the lower surface of the reflector 130 may be perpendicular to each other. For example, the first side surface 130a of the reflector 130 may be a side surface of the reflector 130 which is farthest from the light emission unit 120. Thereby, the reflector 130 may be stably supported by the lower and side surfaces of the housing 110, and the protruding parts 160-1 to 160-m (m being a natural number>1) may be stably supported by the reflective surface 112.

The reflective surface 112 may include a curved surface having a constant curvature in the first direction 101. For example, the reflective surface 112 may include a curved surface part S1 and a flat surface part S2, sequentially arranged in the first direction 101. The curved surface part S1 of the reflective surface 112 may be a curved surface having a predetermined curvature, and the flat surface part S2 may be a flat surface being parallel to the first direction 101.

At least a portion of the curved surface part S1 of the reflective surface 112 may be aligned with or be opposite to the light emission unit 120 in the first direction 101. The curvature of the curved surface part S1 of the reflective surface 112 may be constant but is not limited thereto, and, in accordance with another embodiment, the curved surface part S1 of the reflective surface 112 may include two or more curved surfaces having different curvatures and being located adjacent to each other.

The flat surface part S2 of the reflective surface 112 may be located between the curved surface part S1 and the other side surface 130b of the reflector 130, and be adjacent to the side surface 130b of the reflector 130. The reflector 130 may include a staircase part 114a provided adjacent to one end of the flat surface part S2 of the reflector 130 so as to support one end of the board 124 of the heat emission unit 120.

As exemplarily shown in FIG. 2, the reflector 130 a protrusion 114 contacting one end of the flat surface part S2 of the reflective surface 130 and protruding in the upward direction, and the staircase part 114a to support one end of the board 124 may be provided on the protrusion 114. The staircase part 114a may have a height difference with the upper surface of the protrusion 114.

The board 122 of the light emission unit 120 may be inserted into or seated in a space between the staircase part 114a of the reflective surface 130 and the inner surface of the housing 110 and thus fixed, and an upper surface 122a of the board 122, on which the light emitting devices 124-1 to 124-n (n being a natural number>1) are arranged, may face the curved surface part S1 of the reflective surface 112.

A length of the curved surface part S1 of the reflective surface 112 in the first direction may be greater than a length of the flat surface part S1 in the first direction. The reason for this is that the reflective surface 112 having such a structure may easily reflect light, radiated from the light emission unit 120, upwardly to the diffusion plate 150.

The reflector 130 may be formed of a resin having high reflectivity, for example, polyethylene terephthalate (PET), but is not limited thereto.

The protruding parts 160-1 to 160-m (m being a natural number>1) may be arranged so as to be spaced apart from one another in the second direction, and protrude from the reflective surface 130 in the upward direction. Here, the upward direction may be a direction from the reflective surface 130 to the diffusion plate 150.

Each of the protruding parts 160-1 to 160-m (m being a natural number>1) may have a linear shape having a length thereof in the first direction 101 which is greater than a length thereof in the second direction 102. For example, each of the protruding parts 160-1 to 160-m (m being a natural number >1) may protrude from the reflective surface 112 continuously from one end to the other end of the reflective surface 112, and both ends of the reflective surface 112 may face each other in the first direction.

Each of the protruding parts 160-1 to 160-m (m being a natural number>1) may be arranged on the curved surface part S1 and the flat surface part S2 of the reflective surface 112.

Each of the protruding parts 160-1 to 160-m (m being a natural number>1) may be implemented in various shapes.

Each of the protruding parts 160-1 to 160-m (m being a natural number>1) may be formed of a reflective material which may reflect light. For example, the protruding parts 160-1 to 160-m (m being a natural number>1) may be formed of the same material as the reflector 130 and be formed integrally with the reflector, but the disclosure is not limited thereto and, in accordance with another embodiment, the protruding parts 160-1 to 160-m (m being a natural number>1) may be formed of a material differing from that of the reflector 130.

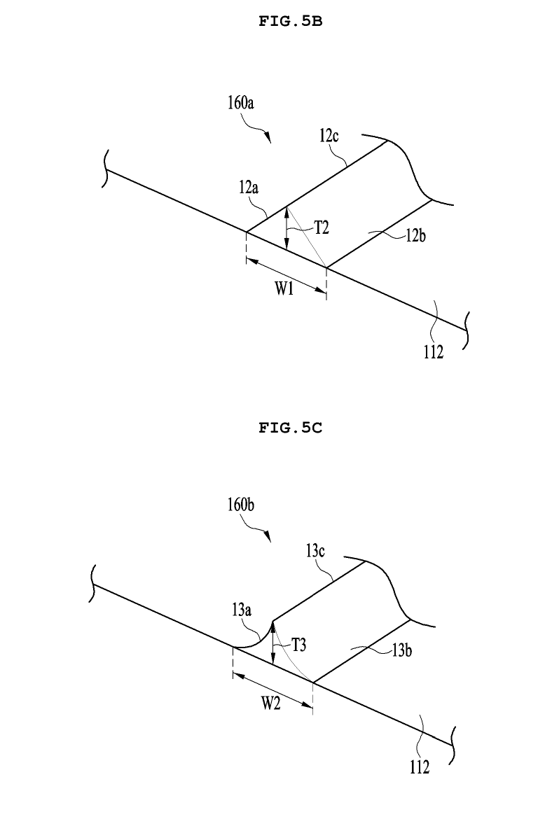

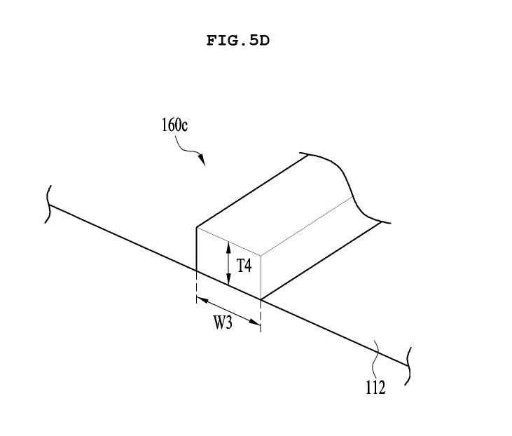

FIG. 5A is a view illustrating a protruding part shown in FIG. 4 in accordance with one embodiment.

With reference to FIG. 5A, the protruding part 160-1 may be a linear protrusion having a curved surface 11 and a semicircular cross-section taken in the second direction 102, and the semicircular cross-section may have a predetermined diameter R. The predetermined diameter R may be less than a length of the protruding part 160-1. The diameter R of the protruding part 160-1 may be 1 m˜2 mm. For example, the diameter R of the protruding part 160-1 may be 1.5 mm. If the diameter R of the protruding part 160-1 is less than 1 mm or exceeds 2 mm, uniformity of luminance of a B-line of the lighting device 100 may be lowered.

FIG. 5B is a view illustrating a protruding part 160a shown in FIG. 4 in accordance with another embodiment.

With reference to FIG. 5B, the protruding part 160a may have a linear protrusion, having two side surfaces 12a and 12b and a first corner 12c formed at the interface of the side surfaces 12a and 12b, and a triangular cross-section taken in the second direction 102.

FIG. 5C is a view illustrating a protruding part 160b shown in FIG. 4 in accordance with another embodiment.

With reference to FIG. 5C, the protruding part 160b may have a linear protrusion, having two side surfaces 13a and 13b and a first corner 13c formed at the interface of the side surfaces 12a and 12b. Here, the side surfaces may be concave surfaces.

FIG. 5D is a view illustrating a protruding part 160c shown in FIG. 4 in accordance with another embodiment.

With reference to FIG. 5D, the protruding part 160c may have a linear protrusion having a rectangular cross-section. In accordance with other embodiments, protruding parts having polygonal cross-sections may be provided.

The respective protruding parts 160-1 to 160-m (m being a natural number>1) may have the same shape, without being limited thereto, and, in accordance with another embodiment, at least one of the protruding parts 160-1 to 160-m (m being a natural number>1) may have a shape differing from that of other protruding parts 160-1 to 160-m (m being a natural number>1).

The protruding parts shown in FIGS. 5A to 5D may have predetermined widths R, W1, W2 and W3 and predetermined thicknesses T1, T2, T3 and T4. For example, the width of the protruding part may be a length of one end of the protruding part in the second direction, and the thickness of the protruding part may be a distance from the reflective surface 112 to the highest point of the protruding part. Each of the protruding parts may have a constant width and a constant thickness in the length direction. An interface between the lower surface of each of the protruding parts 160-1 to 160-m (m being a natural number>1) and the reflective surface 112 may be a curved surface.

For example, a curvature of the interface between the lower surface of each of the protruding parts 160-1 to 160-m (m being a natural number>1) and the reflective surface 112 may be equal to the curvature of the reflective surface 112, without being limited thereto. In accordance with another embodiment, the curvature of the interface between the lower surface of each of the protruding parts 160-1 to 160-m (m being a natural number >1) and the reflective surface 112 and the curvature of the reflective surface 112 may be different.

Each of the protruding parts 160-1 to 160-m (m being a natural number>1) may reflect light radiated from the light emission unit 120, the reflected light may be diffused to the left and right sides of the protruding part and, thus, uniformity of luminance of the lighting device 100 in the second direction 101 may be improved.

The support frame 140 is arranged on the light emission unit 120 and supports the diffusion plate 150.

The support frame 140 may be arranged on the other end of the board 124 and be supported by the other end of the board 124. One end of the lower surface of the support frame 140 may contact the other end of the board 124. The support frame 140 may be formed of plastic or a metal.

The diffusion plate 150 may be arranged on the reflective surface 112 and transmit light reflected by the reflective surface 112. The diffusion plate 150 may serve to diffuse incident light through refraction or scattering. For example, the diffusion plate 150 may be formed of a polyester or polycarbonate-based material, without being limited thereto.

A staircase part 132 to receive one end of the diffusion plate 150 seated thereon may be provided at the upper end of the reflector 130. The staircase part 132 of the reflector 130 may have a constant height difference with the upper surface of the reflector 130.

Adhesive members 145 may be arranged between one end of the diffusion plate 150 and the staircase part 132 of the reflector 130 and between the other end of the diffusion plate 150 and one end of the support plate 140, and the end of the diffusion plate 150 may be fixed to the staircase part 132 of the reflector 130 and the other end of the diffusion plate 150 may be fixed to the support plate 140 by the adhesive members 145.

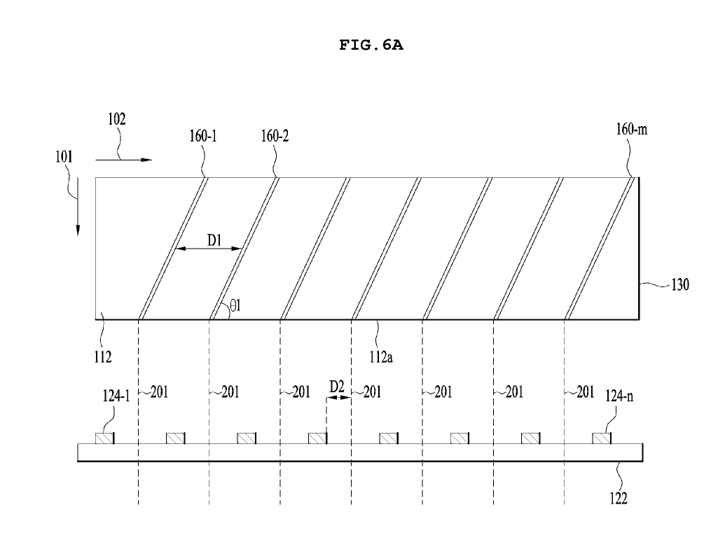

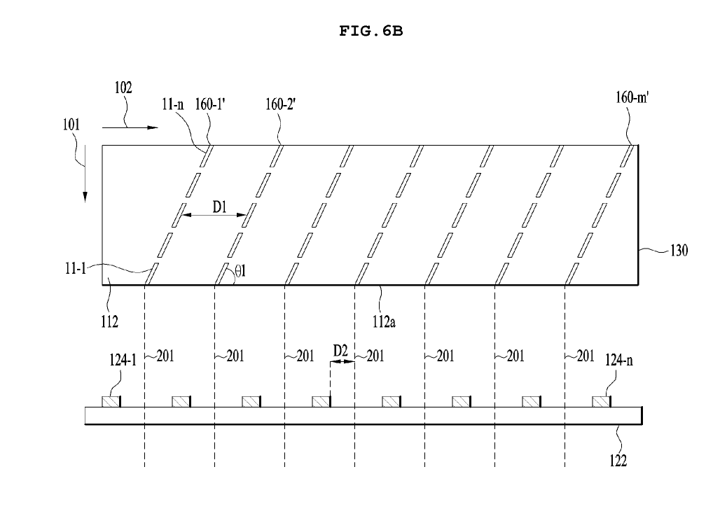

FIG. 6A is a view illustrating arrangement relations between the light emitting devices 124-1 to 124-n (n being a natural number>1) of the light emission unit 120 and the protruding parts 160-1 to 160-m (m being a natural number>1).

With reference to FIG. 6A, each of the protruding parts 160-1 to 160-m (m being a natural number>1) may be arranged so as to be inclined at a predetermined angle θ1 from a reference horizontal line 112a.

For example, the reference horizontal line 112a may be a virtual straight line being parallel to the second direction 102 or the length direction of the reflective surface 130, or be a straight line being parallel to the length direction of the flat surface part S2 of the reflective surface 130.

The protruding parts 160-1 to 160-m (m being a natural number>1) may be arranged on the reflective surface 112 so as to be spaced apart from one another obliquely, and distances D1 between two neighboring protruding parts may be equal. The distance D1 between two neighboring protruding parts may be uniform from ends of the two protruding parts to the other ends of the two protruding parts.

For example, a distance between ends of two neighboring protruding parts may be equal to a distance between the other ends of the two neighboring protruding parts.

The light emission unit 120 may include the light emitting devices 124-1 to 124-n (n being a natural number>1) corresponding to the protruding parts 160-1 to 160-m (m being a natural number>1).

For example, each of the light emitting devices 124-1 to 124-n (n being a natural number>1) may be arranged so as to be aligned at a position spaced apart from one end of the corresponding protruding part by a predetermined distance D2 to one side of the corresponding protruding part.

The distance D2 between the light emitting device and the protruding part corresponding to each other in the second direction may be directly proportional to a distance between the light emitting devices. For example, the distance D2 may be 10 mm˜30 mm, without being limited thereto.

For example, D2 may be a distance from a reference vertical line 201 to the light emitting device corresponding thereto. The reference vertical line 201 may be a virtual straight line passing through one end of the protruding part corresponding to the light emitting device and being parallel to the first direction 101. For example, the reference vertical line 201 may be a virtual straight line passing through one end of the protruding part corresponding to the light emitting device and being perpendicular to the upper surface of the board 122.

FIG. 6B is a view illustrating a plurality of protruding parts 160-1′ to 160-m′ (m being a natural number>1) in accordance with another embodiment.

With reference to FIG. 6B, each of the protruding parts 160-1′ to 160-m′ (m being a natural number>1) may include a plurality of divided protrusions 11-1 to 11-n (n being a natural number>1) arranged so as to be spaced apart from one another in the first direction 101 or in the length direction. Each of the protrusions 11-1 to 11-n (n being a natural number>1) may have a linear shape.

For example, lengths of the corresponding protrusions 11-1 to 11-n (n being a natural number>1) included in the protruding parts 160-1′ to 160-m′ (m being a natural number>1) may be the same.

Further, for example, lengths of the respective protrusions 11-1 to 11-n (n being a natural number>1) may be the same, without being limited thereto.

In accordance with another embodiment, at least one of the protrusions 11-1 to 11-n (n being a natural number>1) may have a length differing from that of other protrusions 11-1 to 11-n (n being a natural number>1). For example, lengths of the respective protrusions 11-1 to 11-n (n being a natural number>1) may be different.

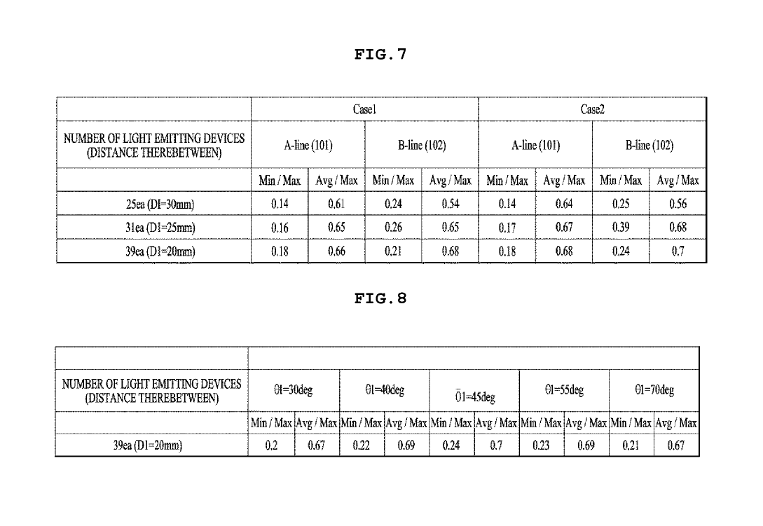

FIG. 7 is a table representing results of a simulation illustrating uniformities of luminance of an A-line and a B-line of a lighting device 100 in accordance with one embodiment. Case 1 represents results of a simulation illustrating luminance of a lighting device including no protruding parts, and Case 2 represents results of a simulation illustrating luminance of the lighting device including the protruding parts 160-1′ to 160-m′ (m being a natural number>1) in accordance with the embodiment. Here, the protruding parts may have the shape shown in FIG. 5A, and the diameter R of the protruding parts may be 1.5 mm.

Uniformity of luminance of the A-line represents uniformity of luminance of the lighting device in the first direction 101, and uniformity of luminance of the B-line represents uniformity of luminance of the lighting device in the second direction 102.

Min indicates a minimum luminance value of the A-line (or the B-line), Max indicates a maximum luminance value of the A-line (or the B-line) and Avg indicates an average luminance value of the A-line (or the B-line). FIG. 7 represents a ratio of the minimum luminance value to the maximum luminance value of the A-line or the B-line and a ratio of the average luminance value to the maximum luminance value of the A-line or the B-line.

With reference to FIG. 7, uniformity of luminance of the A-line of Case 1 and uniformity of luminance of the A-line of Case 2 are almost similar to each other. For example, if the number of light emitting devices is 25 or 39, a ratio of Min/Max of the A-line of Case 1 and a ratio of Min/Max of the A-line of Case 2 may be the same and, if the number of light emitting devices is 31, a difference between a ratio of Min/Max of the A-line of Case 1 and a ratio of Min/Max of the A-line of Case 2 may be 0.01. Further, a difference between a ratio of Avg/Max of the A-line of Case 1 and a ratio of Avg/Max of the A-line of Case 2 is within a range of 0.03 or less. Therethrough, it may be confirmed that uniformity of luminance of the A-line may be maintained.

As compared to Case 1, uniformity of luminance of the B-line of Case 2 may be improved.

As compared to a ratio of Min/Max of the B-line and a ratio of Avg/Max of the B-line of Case 1, if the number of the light emitting devices is 25, 31 or 39, both a ratio of Min/Max of the B-line and a ratio of Avg/Max of the B-line of Case 2 are increased and thus the embodiment may improve uniformity of luminance of the B-line.

FIG. 8 is a table representing results of a simulation in which uniformity of luminance of the B-line according to change in the angle θ1 of FIG. 6A is measured. In FIG. 8, the number of light emitting devices of the light emission unit 120 may be 39, and a distance D1 between two neighboring protruding parts may be 20 mm. The protruding parts may have the shape shown in FIG. 5A, and the diameter R of the protruding parts may be 1.5 mm.

With reference to FIG. 8, a ratio of Min/Max and a ratio of Avg/Max of the B-line are increased when the angle θ1 is increased from 30° to 45°, and are decreased when the angle θ1 is increased from 45° to 70°. The ratio of Min/Max and the ratio of Avg/Max of the B-line may have the maximum values when the angle θ1 is 45°.

The angle θ1 may be 30° to 70°. If the angle θ1 is less than 30° or exceeds 70°, the ratio of Min/Max of the B-line is less than 0.2 and, thus, improvement in uniformity of luminance of the B-line is insignificant.

As exemplarily shown in FIG. 8, the angle θ1 may be 40° to 55°. When the angle θ1 is 40° to 55°, the ratio of Min/Max of the B-line may be 0.22˜0.24, the ratio of Avg/Max of the B-line may be 0.69˜0.7, and uniformity of luminance of the B-line may be further improved. For example, the angle θ1 may be 45°. When the angle θ1 may be 45°, the ratio of Min/Max and the ratio of Avg/Max of the B-line may have the maximum values and, thus, uniformity of luminance of the B-line may be maximally improved.

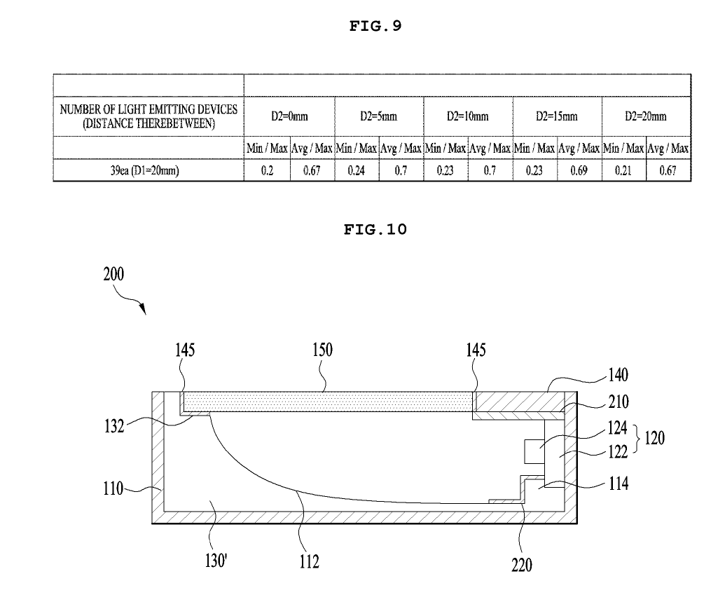

FIG. 9 is a table representing results of a simulation in which uniformity of luminance of the B-line according to change of the distance D2 of FIG. 6A is measured. In FIG. 9, the number of light emitting devices of the light emission unit 120 may be 39, and a distance D1 between two neighboring protruding parts may be 20 mm. The protruding parts may have the shape shown in FIG. 5A, and the diameter R of the protruding parts may be 1.5 mm.

With reference to FIG. 9, a ratio of Min/Max and a ratio of Avg/Max of the B-line are increased when the distance D2 is increased from 0 mm to 5 mm, and are decreased when the distance D2 is increased from 5 mm to 20 mm. The ratio of Min/Max and the ratio of Avg/Max of the B-line may have the maximum values when the distance D2 is 5 mm.

The distance D2 may be 0 mm to 20 mm. When the distance D2 is 0 mm, each of the light emitting devices 124-1 to 124-n (n being a natural number>1) may be arranged so as to be aligned at one end of the corresponding protruding part. When D2 exceeds 20 mm, the ratio of Min/Max of the B-line is less than 0.2 and, thus, improvement in uniformity of luminance of the B-line is insignificant.

Further, the distance D2 may be 5 mm ˜15 mm. When distance D2 is 5 mm˜15 mm, the ratio of Min/Max of the B-line may be 0.23˜0.24, uniformity of luminance of the B-line may be further improved.

Further, the distance D2 may be 5 mm. When the distance D2 is 5 mm, the ratio of Min/Max and the ratio of Avg/Max of the B-line may have the maximum values and, thus, uniformity of luminance of the B-line may be maximally improved.

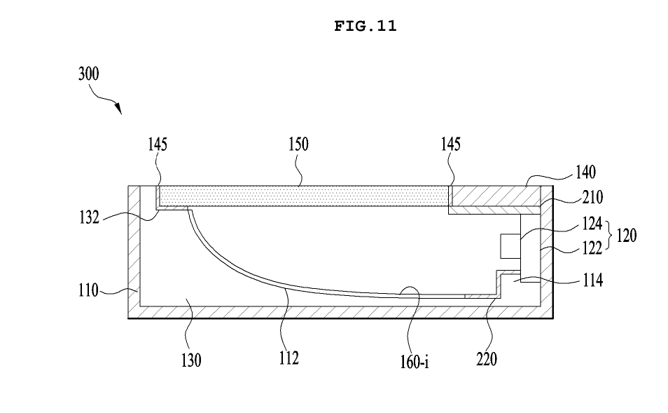

FIG. 10 is a cross-sectional view of a lighting device 200 in accordance with another embodiment. Some parts in this embodiment, which are substantially the same as those in the embodiment shown in FIG. 2, are denoted by the same reference numerals even though they are depicted in different drawings and a detailed description thereof will thus be simplified or omitted because it is considered to be unnecessary.

With reference to FIG. 10, the lighting device 200 includes a housing 110, a light emission unit 120, a reflector 130′, a support frame 140, a diffusion plate 150, a first reflective member 210 and a second reflective member 220.

The reflector 130′ shown in FIG. 10 may be a structure acquired by removing a plurality of protruding parts from the reflector 130 shown in FIG. 2.

The first reflective member 210 may be arranged on the lower surface of the support frame 140 so as to contact the lower surface of the support frame 140, and reflect light radiated from the light emission unit 120.

The second reflective member 220 may be arranged on a reflective surface 112 so as to face the first reflective member 210. For example, the second reflective member 220 may be arranged on a flat surface part S2 of the reflective surface 112. For example, the second reflective member 220 may be arranged on the upper surfaces of the flat surface parts S2 and a protrusion 114.

The first and second reflective members 210 and 220 may be formed of a metal, such as aluminum or silver, but is not limited thereto. The first and second reflective members 210 and 220 may reflect light, radiated from the light emission unit 140, to a curved surface part S1 of the reflective surface 112.

The first and second reflective members 210 and 220 may prevent optical loss due to scattered reflection of light around the light emission unit 120 and thus improve luminous efficacy and uniformity of luminance.

FIG. 11 is a cross-sectional view of a lighting device 300 in accordance with yet another embodiment. Some parts in this embodiment, which are substantially the same as those in the embodiment shown in FIG. 2, are denoted by the same reference numerals even though they are depicted in different drawings and a detailed description thereof will thus be simplified or omitted because it is considered to be unnecessary.

With reference to FIG. 11, the lighting device 300 further includes a first reflective member 210 and a second reflective member 220 in addition to the lighting device 100 shown in FIG. 1.

The first and second reflective members 210 and 220 may be the same as those described in FIG. 10.

In the embodiment shown in FIG. 11, the protruding parts 160-1′ to 160-m′ (m being a natural number>1) together with the first and second reflective members 210 and 220 may prevent optical loss and thus further improve luminous efficacy and uniformity of luminance.

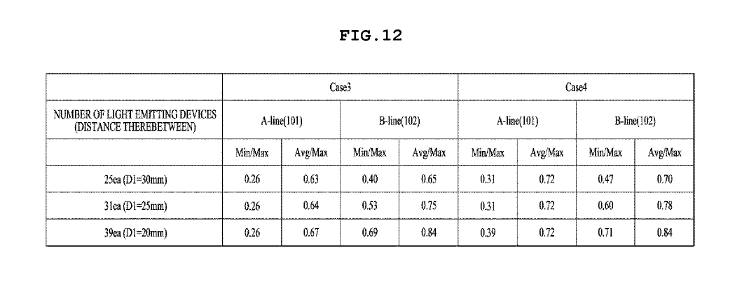

FIG. 12 is a table representing results of a simulation illustrating uniformities of luminance of an A-line and a B-line of the lighting device 200 shown in FIG. 10. Case 3 represents results of a simulation illustrating luminance of a lighting device including no first and second reflective members 210 and 220, and Case 4 represents results of a simulation illustrating luminance of the lighting device shown in FIG. 10.

With reference to FIG. 12, as compared to Case 3, uniformity of luminance of the A-line and uniformity of luminance of the B-line of Case 4 may be simultaneously improved.

If the number of light emitting devices is 25 and a distance D1 is 30 mm, a ratio of Min/Max of the A-line of Case 4 is increased by 0.05 and a ratio of Min/Max of the B-line of Case 4 is increased by 0.07, as compared to a ratio of Min/Max of the A-line and a ratio of Min/Max of the B-line of Case 3.

If the number of the light emitting devices is 31 and the distance D1 is 25 mm or if the number of the light emitting devices is 39 and the distance D1 is 20 mm, a ratio of Min/Max of the A-line and a ratio of Min/Max of the B-line of Case 4 are greater than a ratio of Min/Max of the A-line and a ratio of Min/Max of the B-line of Case 3.

Therefore, the embodiment may improve both uniformity of luminance of the A-line and uniformity of luminance of the B-line.

The lighting devices in accordance with the above-described embodiments may be used as display apparatuses, lighting lamps, lamps, streetlamps, or head lamps, without being limited thereto.

Although embodiments have been described with reference to a number of illustrative embodiments thereof, it should be understood that numerous other modifications and embodiments can be devised by those skilled in the art that will fall within the spirit and scope of the principles of the disclosure. More particularly, various variations and modifications are possible in the component parts and/or arrangements of the subject combination arrangement within the scope of the disclosure, the drawings and the appended claims. Therefore, it should be understood that differences regarding the modifications and applications are within the spirit and scope of the disclosure which is defined in the appended claims and their equivalents.

### INDUSTRIAL APPLICABILITY

Embodiments are usable in a lighting device which may improve uniformity of luminance.

1. A lighting device comprising:
a light emission unit comprising a board and a plurality of light emitting devices arranged on the board;
a reflector having a reflective surface facing the light emitting devices; and
a plurality of protruding parts arranged on the reflective surface to be spaced apart from one another so as to correspond to the light emitting devices and reflecting light radiated from the light emitting devices, wherein:
each of the protruding parts has a shape having a length thereof in a first direction being greater than a length thereof in a second direction; and
the reflective surface comprises a curved surface part being curved in the first direction,
wherein the first direction is a direction from the reflective surface to the light emission unit, and the second direction is perpendicular to the first direction.

2. The lighting device according to claim 1, wherein an interface between the lower surface of each of the protruding parts and the reflective surface is a curved surface.

3. The lighting device according to claim 1, wherein:
the protruding parts are arranged on the reflective surface so as to be spaced apart from one another obliquely from a reference horizontal line; and
the reference horizontal line is a virtual straight line being parallel to the second direction.

4. The lighting device according to claim 3, wherein distances between two neighboring protruding parts out of the protruding parts are the same.

5. The lighting device according to claim 1, wherein each of the protruding parts protrudes continuously from one end of the reflective surface to the other end of the reflective surface.

6. The lighting device according to claim 3, wherein an angle formed by each of the protruding parts and the reference horizontal line is 40°˜55°.

7. The lighting device according to claim 1, wherein:
a distance between each of the light emitting devices and a reference vertical line is 5 mm˜15 mm; and
the reference vertical line is a virtual straight line passing through one end of one of the protruding parts corresponding to the light emitting device and being parallel to the first direction.

8. The lighting device according to claim 1, wherein each of the protruding parts has a semicircular cross-section taken in the second direction.

9. The lighting device according to claim 1, wherein:
the reflective surface further comprises a flat surface part contacting the curved surface part and being flat; and
each of the protruding parts is arranged on the curved surface part and the flat surface part.

10. The lighting device according to claim 1, further comprising:
a support frame having a lower surface provided with one end contacting an upper end of the board; and
a diffusion plate fixed to the end of the support frame and the upper end of the board.

11. The lighting device according to claim 10, further comprising:
a first reflective member arranged on the lower surface of the support frame; and
a second reflective member arranged on the reflective surface so as to face the first reflective member.

12. The lighting device according to claim 9, wherein the reflector comprises a protrusion contacting one end of the flat surface part and protruding upwardly, and a staircase part supporting the board is provided on the protrusion.

13. The lighting device according to claim 4, wherein a distance between ends of two neighboring protruding parts is equal to a distance between the other ends of the two neighboring protruding parts.

14. The lighting device according to claim 1, wherein each of the protruding parts has constant width and thickness in the length direction thereof.

15. The lighting device according to claim 1, wherein the protruding parts are formed of a reflective material.

16. The lighting device according to claim 1, wherein each of the protruding parts comprises a plurality of divided protrusions arranged so as to be spaced apart from one another.

17. The lighting device according to claim 10, further comprising a housing having a cavity to receive the light emission unit, the reflector, the protruding parts, the support frame and the diffusion plate.

18. The lighting device according to claim 1, wherein a distance from a first side surface of the reflector to the reflective surface is gradually decreased in a direction from a lower end to an upper end of the reflector.

19. A lighting device comprising:
a light emission unit comprising a board and a plurality of light emitting devices arranged on the board;
a reflector comprising a reflective surface comprising a curved surface facing the light emitting devices, and a plurality of protruding parts arranged on the reflective surface; and
a diffusion plate arranged on the reflector and transmitting light reflected by the reflective surface, wherein:
each of the protruding parts has a shape having a length thereof in a first direction being greater than a length thereof in a second direction, and is arranged on the reflective surface obliquely so as to correspond to one of the light emitting devices; and
an angle formed by each of the protruding parts and a reference horizontal line is 40°˜55°, the first direction is a direction from the reflective surface to the light emission unit, the second direction is perpendicular to the first direction, and the reference horizontal line is a virtual straight line being parallel to the second direction.

20. A lighting device comprising:
a light emission unit comprising a board and a plurality of light emitting devices arranged on the board;
a reflector comprising a reflective surface comprising a curved surface facing the light emitting devices, and a plurality of protruding parts arranged on the reflective surface so as to correspond to the light emitting devices; and
a diffusion plate arranged on the reflector and transmitting light reflected by the reflective surface, wherein:
each of the protruding parts has a shape having a length thereof in a first direction being greater than a length thereof in a second direction, and the protruding parts are arranged on the reflective surface so as to be spaced apart from one another obliquely;
a distance between each of the light emitting devices and a reference vertical line is 5 mm˜15 mm; and
the reference vertical line is a virtual straight line passing through one end of the protruding part corresponding to each of the light emitting devices and being parallel to the first direction.
